(19) United States
(12) Patent Application Publication
(10) Pub. No.: US 2005/0216133 A1
(43) Pub. Date: Sep. 29, 2005

(54) Child lock indicator

(76) Inventors: Lonny MacDougall, Phoenix, AZ (US); Edward H. Arnold JR., Arroyo Grande, CA (US)

Correspondence Address: Steven Thrasher, 391 Sandhill Dr., Richardson, TX, 75080, US

(21) Appl. No.: 10/810,794

(22) Filed: Mar. 25, 2004

(51) Int. Cl. G06F 17/00

(52) U.S. Cl. 701/1; 701/36; 340/425.5

(57) ABSTRACT

The invention is a system that displays the status of a motor vehicle child lock.

### TECHNICAL FIELD

The invention relates generally to motor vehicles, and more particularly, the invention relates to door lock systems for motor vehicles.

### STATEMENT OF A PROBLEM ADDRESSED BY THE INVENTION

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Statement of a Problem Addressed by This Invention is to be construed as prior art.

Discussion

One of the most frightening events a parent will ever endure is that of having a child open a door of a moving automobile or other motor vehicle. Although the statistics on the number of incidents of children opening doors in moving motor vehicles are not available, the frequency of such occurrences were such that motor vehicle manufacturers have for some time installed child lock safety systems (child locks) so that when engaged, certain motor vehicle systems will not operate.

For example, when child locks are engaged in some vehicles, only the driver's door may be opened from inside. In other motor vehicles, when a child lock is engaged, only the doors in the front of the motor vehicle will open from inside; Still, at other times, when a child lock system is engaged, one cannot operate a window from the back seat of a motor vehicle. Accordingly, child lock systems prevent children from being able to independently exit a motor vehicle whether it is moving or not unless the driver of the motor vehicle disengages the child lock system. However, child locks are not without frustrations.

Sometimes, an adult will sit in the back of a motor vehicle. Then, when the motor vehicle comes to a halt and the front passengers disembark, the rear seat passengers are locked in the motor vehicle and are unable to exit. In addition, sometimes the occupants in the rear seat of a motor vehicle will wish to control the opening or closing of a window, and find their desires frustrated. Accordingly, it would be advantageous to have systems and methods that prevent adults enduring the inconveniences of being placed in a rear seat of a motor vehicle that has a child lock system engaged. The present invention provides such systems and methods.

### BRIEF DESCRIPTION OF THE DRAWINGS

Various aspects of the invention, as well as at least one embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 illustrates a child lock indicator system; and

FIG. 2 shows a rear seat interior view of the child lock indicator system as implemented in a motor vehicle.

### AN EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for —functioning—” or “step for —functioning—” in the Claims section. The invention is also described in view of the Festo decisions, and, in that regard, the claims and the invention incorporate equivalents known, foreseeable, and unforeseeable.

Discussion of the Figures

The invention can be characterized as a child lock indicator. The child lock indicator provides some warning to a person entering a vehicle that the child-lock is engaged so that the person can direct the child lock system to be disengaged. Accordingly, the invention prevents the frustrations that occur when one is trapped in a rear seat of an automobile due to the child lock system being engaged.

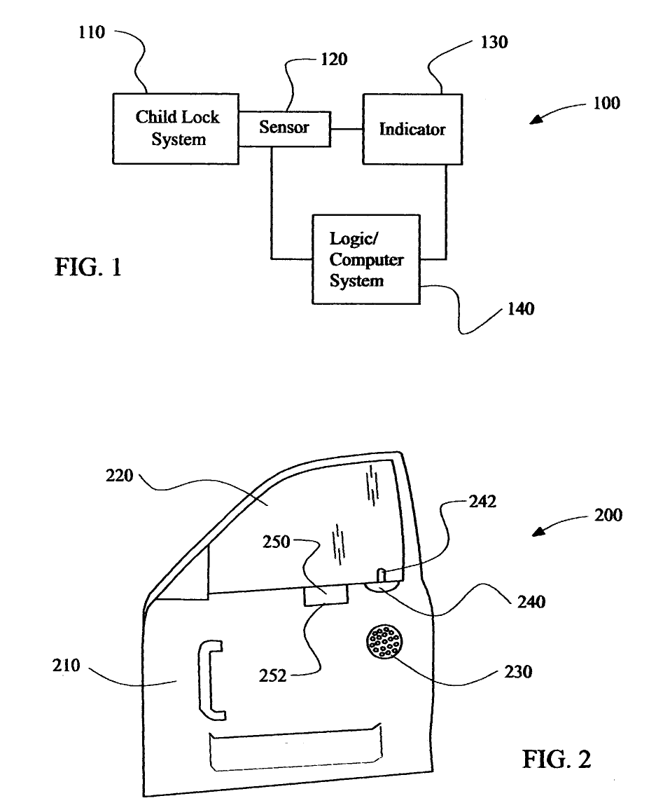

FIG. 1 illustrates a child lock indicator system. The child lock indicator system 100 generally includes a motor vehicle child lock system 110, and a sensor 120 that is adapted to detect when the child lock system 110 is engaged. In addition, the child lock indicator system 100 also includes an indicator 130 which is coupled to the sensor 120. The child lock system 110 is a standard child lock system used in practically any motor vehicle, including child lock systems that will be developed and installed in motor vehicles in the future. The sensor 120 is any wireless, electronic, or mechanical sensing system that can detect the state of a child lock as either engaged (the child lock system being on), or disengaged (the child lock system being off) and then produces a signal receivable by the indicator 130 to announce the state of the child lock system 110.

The indicator 130 is preferably located approximate to a lock that is controlled by the child lock system 110. In general, the indicator 130 is any system or device capable of alerting a person that the child lock system is engaged. In one embodiment, the indicator includes a light, such as a Light Emitting Diode (LED), and preferably a red LED. In an alternative embodiment, the indicator 130 is a speaker, which may play audible sounds or voice recordings to indicate that the child lock system 110 is engaged. Accordingly, the indicator 130 may comprise the speaker system that comes with the motor vehicle, or may work in conjunction with that system.

In one embodiment, the child lock indicator system 100 also includes a logic/computer system (logic) 140 coupled between the sensor 120 and the indicator 130. The logic/computer system 140 is preferably adapted to record a message, and then play a message on a speaker when the sensor indicates that the child lock system is engaged, and when a second sensor 122 also coupled to the logic/computer system 140, receives an indication that a vehicle door is open. Accordingly, the logic/computer system 140 controls the indicator 130 in one embodiment by turning the indicator on only when a predetermined set of environmental conditions are met (in this example, the open state of a motor vehicle door and the engagement of child lock system 110). In addition, the logic/computer system 140 is adapted to record a message that may be played when a certain set of environmental conditions are detected.

FIG. 2 shows a rear seat interior view of the child lock indicator system as implemented in a motor vehicle. The motor vehicle door 200 is shown having a window 220 and a door interior 210. The door interior 210 in a preferred embodiment maintains at least one child lock indicator system 100 indicator. For example, the door 200 includes a speaker 230 for producing an audible warning. In addition, the door 200 includes an indicator embodied as a light 240 coupled about a lock 242 in the door 200.

Further, the door 200 includes a mechanical indication of the status of the child lock system 110 as a plate 250 having the word “locked” upon it. Thus, when the child lock system is disengaged a plate without any word on it may cover the word “locked”, similarly, when the child lock system 110 is engaged, the plate with the word “locked” on it 252 may appear in a window in the door 200.

The invention may also be characterized as a method of displaying the status of a motor vehicle child lock. The method typically includes detecting the status of a motor vehicle child lock system, and displaying an indication of the child lock system so that a motor vehicle user may know whether the child lock system is engaged or disengaged. In one embodiment, the method displays a light as an indication that the child lock system is engaged, and preferably the light is red. Alternatively, the method displays an audible warning or other indication that the child lock system is engaged. Preferably, the audible warning is a spoken word or phrase such as “the child lock system is engaged” or perhaps a single word such as “engaged”. In yet another alternative embodiment, the method articulates a mechanical indication of the status of the child lock system.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention, and it should be understood that the invention is not limited by the detailed description. Accordingly, the invention should be read as being limited only by the claims.

Thus, though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

1. A system that displays the status of a motor vehicle child lock, comprising:
a motor vehicle child lock located in a motor vehicle door;
a sensor that is adapted to detect whether the child lock is engaged or disengaged; and
an indicator coupled to the sensor, the indicator providing the status of the child lock as being either engaged or disengaged when the door is in an open position.

2. The system of claim 1 wherein the indicator includes a light.

3. The system of claim 1 wherein the indicator light is a red LED.

4. The system of claim 1 wherein the indicator is a speaker.

5. The system of claim 1 wherein the indicator is a mechanical indicator.

6. The system of claim 1 further comprising a computer system that is adapted to record a sound, and play the sound on a speaker.

7. The system of claim 1 further comprising logic adapted to control the indicator, the logic coupled between the indicator and the child lock.

8. The system of claim 1 further comprising a door lock coupled to the indicator, the indicator being a light that is embedded in the door lock.

9. The system of claim 1 wherein the indicator is located approximate to the lock that is controlled by the child lock.

10. A method of displaying the status of a motor vehicle child lock, comprising:
detecting the status of a motor vehicle child lock system when a vehicle door opens;
displaying an indication of the child lock system status on an indicator that provides the status of the child lock as being either engaged or disengaged when the door is in an open position.

11. The method of claim 10 wherein displaying occurs in an area approximate to a lock that is disengage able by the child lock system.

12. The method of claim 10 wherein displaying produces a light.

13. The method of claim 12 wherein the light is red.

14. The method of claim 10 wherein displaying sounds an audible warning.

15. The method of claim 10 wherein displaying provides a mechanical indication.

16. The method of claim 15 wherein the mechanical indication is a word.

17. The method of claim 14 wherein the audible warning is a verbal warning.
